(19) United States
(12) Patent Application Publication
(10) Pub. No.: US 2021/0094795 A1
(43) Pub. Date: Apr. 1, 2021

(54) CONTROLLING MOVEMENT OF AN ELEVATOR CAR OF AN ELEVATOR SYSTEM

(71) Applicant: Otis Elevator Company, Farmington, CA (US)

(72) Inventors: Alexander Paetow, Berlin (DE); Axel Steffen Pfeffer, Berlin (DE); Peter Herkel, Berlin (DE); Mustapha Toutaoui, Berlin (DE)

(21) Appl. No.: 16/835,649

(22) Filed: Mar. 31, 2020

(30) Foreign Application Priority Data
Sep. 26, 2019 (EP) 19199860.8

(51) Int. Cl. B66B 1/36; B66B 1/34; B66B 1/22; B66B 1/46; B66B 5/00

(52) U.S. Cl. CPC B66B 1/36; B66B 1/3492; B66B 1/22; B66B 5/0056; B66B 1/466; B66B 5/0025; B66B 1/3461

(57) ABSTRACT

Elevator system (2) comprising: a hoistway (4) extending between a plurality of landings (8); at least one elevator car (6) configured for moving along the hoistway (4) between the plurality of landings (8); an elevator drive (5) configured for moving the at least one elevator car (6) along the hoistway (4); and an elevator control (9) configured for controlling the elevator drive (5). The elevator control (9) is configured for selectively operating in a normal operation mode or in a maintenance mode.

### FOREIGN PRIORITY

This application claims priority to European Patent Application No. 19199860.8, filed Sep. 26, 2019, and all the benefits accruing therefrom under 35 U.S.C. § 119, the contents of which in its entirety are herein incorporated by reference.

### BACKGROUND

The invention relates to an elevator system and to a method of controlling the movement of an elevator car of an elevator system.

An elevator system as referred to herein comprises at least one elevator car configured for moving along a hoistway extending between a plurality of landings, and an elevator drive configured for moving the elevator car. In particular embodiments, the elevator system may further include a counterweight moving concurrently and in opposite direction with respect to the elevator car.

For maintenance and/or repair, it might be advantageous to position the elevator car at a specific position (height) within the hoistway, in particular at a predetermined distance from one of the landings or from a bottom of the hoistway.

It therefore would be beneficial to provide an elevator system and a method of moving an elevator car of an elevator system which allow positioning the elevator car at a desired position of the hoistway easily without compromising the safety of the elevator system.

### SUMMARY

Exemplary embodiments of the invention include an elevator system comprising a hoistway extending between a plurality of landings; at least one elevator car configured for moving along the hoistway between the plurality of landings; an elevator drive configured for moving the at least one elevator car along the hoistway; and an elevator control configured for controlling the elevator drive. The elevator control is configured for selectively operating in a normal operation mode or in a maintenance mode. The elevator control is further configured for carrying out the following sequence of steps: (a) switching into a maintenance set-up mode in response to receiving a maintenance mode set-up signal; (b) when switched into the maintenance set-up mode and in response to receiving an input signal, controlling the elevator drive for moving the elevator car in accordance with the normal operation mode to a position specified by the input signal; (c) when the elevator car has reached the specified position, switching into the maintenance mode in response to detecting an opening of at least one door providing access to the hoistway (hoistway door); and (d) in response to detecting that a predefined call button has been operated for at least a predetermined period of time, controlling the elevator drive for moving the elevator car in accordance with the maintenance mode.

Exemplary embodiments of the invention also include a method of moving an elevator car of an elevator system according to an exemplary embodiment of the invention in accordance with a maintenance mode, wherein the method includes the steps of: (a) switching the elevator control of the elevator system into a maintenance set-up mode by providing a maintenance mode set-up signal to the elevator control; (b) when switched into the maintenance set-up mode, providing an input signal for moving the elevator car in accordance with the normal operation mode to a position specified by the input signal; (c) when the car has reached the specified position, opening a door providing access to the hoistway (hoistway door); (d) operating a call button for at least a predetermined period of time for moving the elevator car in accordance with the maintenance mode.

The input signal may be generated by operating an operating element of a hall call/destination call panel on one of the landings, such as a hall call button, or by operating, in particular pressing or pushing, an operating element (“elevator car call button”) of a car operation panel provided within the elevator car.

The position specified by the input signal may be a position corresponding to one of the landings. I.e., after being switched into the maintenance set-up mode, the elevator car may be moved to one of the landings, wherein the landing to which the elevator car is moved is specified by operating, in particular pressing or pushing, a hall call button or an elevator car call button associated with the respective landing.

An elevator system and a method according to exemplary embodiments of the invention allow a service person (mechanic) to safely and conveniently move the elevator car to a desired position within the hoistway, in particular to a position which is advantageous for repairing and/or maintaining components of the elevator system, in particular components attached to the elevator car.

According to exemplary embodiments of the invention, two steps are required for moving the elevator car in the maintenance mode: firstly, switching the elevator control into the maintenance set-up mode via the service panel or service tool, and secondly operating the call button at a desired landing for more than a predetermined period of time. As unauthorized persons, such as ordinary passengers, do not have access to the service panel and/or service tool, the maintenance operation of the elevator system cannot be initiated accidentally or maliciously by unauthorized persons, such as ordinary passengers of the elevator system.

When switched into the maintenance mode and after the call button has been operated at least for the predetermined period of time, the elevator control may be configured for controlling the elevator drive to move the elevator car until it reaches a predetermined position within the hoistway and/or until the call button is released.

As the elevator car does not drive automatically to a predefined position, but a permanent operation of the call button is required for moving the elevator car, the service person is in complete control of the motion of the elevator car. This feature enhances the safety of the elevator system, as an uncontrolled movement of the elevator car is reliably prevented.

A number of optional features are set out in the following. These features may be realized in particular embodiments, alone or in combination with any of the other features.

The elevator control may be configured for controlling the elevator drive for moving the elevator car in accordance with the normal operation mode if the call button is operated shorter than the predetermined period of time. This allows the service person to easily switch the elevator control back from operating in the maintenance mode into operating in the normal operation mode without the need of employing an additional tool.

When switched into the maintenance mode, the elevator control may be configured for controlling the elevator drive to move the elevator car in the opposite direction after the call button has been released and is operated again for at least the predetermined period of time. This feature allows the service person to easily change the moving direction of the elevator car in order to move the elevator car to a desired position, or to a sequence of desired positions, within the hoistway.

The elevator control may be configured for receiving the maintenance mode set-up signal via a service panel, which is integrated and/or electrically connected with the elevator control. A service panel provides an inexpensive and reliable means for inputting signals into the elevator control.

Additionally or alternatively, the elevator control may be configured for receiving the maintenance mode set-up signal via a separate service tool, which is wiredly and/or wirelessly connected with the elevator control. A service tool provided separately from the elevator control provides a convenient means for inputting signals into the elevator control. It in particular allows inputting signals into the elevator control from locations spaced apart from the elevator control.

The service tool may be a dedicated service tool provided by the manufacturer of the elevator system. Alternatively, a smartphone or a tablet computer running an appropriate software program (“App”) may be used as a service tool. If a smartphone or a tablet computer running an appropriate software program is used as a service tool, there is no need for developing and producing dedicated hardware for the service tool. In consequence, the costs may be reduced.

The elevator control may be configured for applying a first set of safety conditions when the elevator car is moved in accordance with the normal operation mode, and the elevator control may be configured for applying a second set of safety conditions, which differs from the first set of safety conditions, when the elevator car is moved in accordance with the maintenance mode.

Applying a different set of safety conditions may include allowing the elevator car to move closer to the ends of the hoistway in the maintenance mode than in the normal operation mode in order to allow moving the elevator car to advantageous maintenance positions.

In order to maintain the safety of the elevator system, the second set of safety conditions applied in the maintenance mode may restrict the maximum speed of the elevator car to a lower value than the first set of safety conditions, which is applied in the normal operation mode.

Applying a different set of safety functions may also include ignoring the signal of at least one (safety) sensor when the elevator system is operated in the maintenance mode.

The at least one sensor in particular may include door sensors configured for detecting whether doors providing access to the hoistway are open or closed and/or sensors detecting the presence of service tools, such as a ladder, provided within the hoistway. The second set of safety conditions may allow moving the elevator car even if at least one door providing access to the hoistway is open and/or when a service tool is not located at its dedicated storage position.

When switched into the maintenance mode, the elevator control may be further configured for controlling the elevator drive to move the elevator car in accordance with an elevator car positioning mode. In the elevator car positioning mode, the top and/or the bottom of the elevator car is automatically positioned at a predetermined distance from a respective one of the landings.

Controlling the elevator drive in such an elevator car positioning mode allows a service person to quickly and reliably move the elevator car into a position allowing easy and convenient access to the top and/or the bottom of the elevator car, in particular access to components of the elevator system located on the top and/or at/below the bottom of the elevator car.

The elevator car positioning mode in particular may include moving the elevator car over a predetermined length from a position in which the elevator car is positioned at one of the landings of the hoistway, i.e. from a position in which the floor of the elevator car is aligned with the floor of one of the landings. The predetermined length in particular may correspond to the height of the elevator car. This allows positioning the top of the elevator car in alignment with, i.e. at the same height as, the floor of the respective landing allowing the service person to step easily from the landing onto the top of the elevator car.

The elevator car positioning mode may further include moving the elevator car over a predetermined length in order to position the bottom or floor of the elevator car in a predefined distance from the floor of one of the landings in order to provide easy access to components arranged at the bottom of the elevator car.

The elevator control may be configured for detecting the time lapsed in between at least two of the steps (a) to (d), in particular between two successive steps. The elevator control further may be configured for switching back into the normal operation mode when it is detected that the time lapsed in between the two steps exceeds a predetermined threshold, e.g. a threshold of 10, 15, 20, or 30 minutes. Such a configuration prevents the elevator system from accidentally operating in the maintenance set-up mode or in the maintenance mode over an extended period of time.

The elevator system may be configured for issuing an optical and/or an acoustical signal while operating in the maintenance set-up mode or in the maintenance mode, respectively, in order to remind the service person that the elevator system is not operating the in the normal operation mode. Different signals may be used for indicating the maintenance set-up mode and the maintenance mode, respectively.

### DRAWING DESCRIPTION

In the following, an exemplary embodiment of the invention is described in more detail with respect to the enclosed figures:

FIG. 1 schematically depicts an elevator system according to an exemplary embodiment of the invention.

FIGS. 2 to 5 schematically illustrate four different steps of operating an elevator system in a maintenance mode according to an exemplary embodiment of the invention.

FIG. 6 depicts the elevator system as it is shown in FIG. 1, in which the top of the elevator car is aligned with one of the landings.

### DETAILED DESCRIPTION

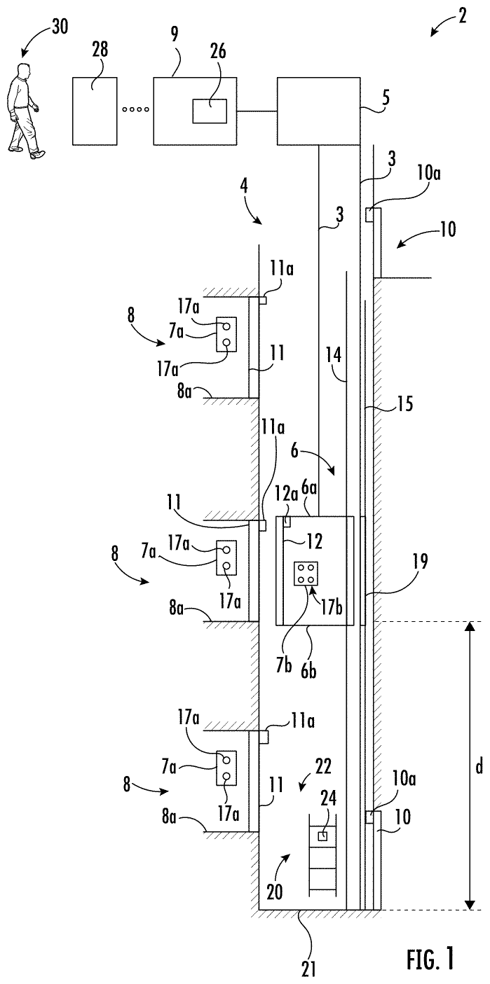

FIG. 1 schematically depicts an elevator system 2 according to an exemplary embodiment of the invention.

The elevator system 2 includes an elevator car 6 having a top (ceiling 6a) and a bottom 6b and movably arranged within a hoistway 4 extending between a plurality of landings 8. The elevator car 6 in particular is movable in a longitudinal (vertical) direction along a plurality of car guide members 14, such as guide rails, extending along the vertical direction of the hoistway 4. Only one of said car guide members 14 is depicted in FIG. 1.

Although only one elevator car 6 is shown in FIG. 1, the skilled person understands that exemplary embodiments of the invention may include elevator systems 2 including a plurality of elevator cars 6 moving in one or more hoistways 4.

The elevator car 6 is movably suspended by means of a driving member (tension member) 3. The driving member 3, for example a rope or belt, is connected to an elevator drive 5, which is configured for driving the driving member 3 in order to move the elevator car 6 along the height of the hoistway 4 between the plurality of landings 8, which are located on different floors.

Details of the roping configuration are not specified in FIG. 1. The skilled person understands that the type of the roping is not essential for the invention and that different kinds of roping, such as a 1:1 roping, a 2:1 roping or a 4:1 roping may be employed.

The driving member 3 may be a rope, e.g. a steel wire rope, or a belt. The driving member 3 may be uncoated or may have a coating, e.g. in the form of a polymer jacket. In a particular embodiment, the driving member 3 may be a belt comprising a plurality of polymer coated steel cords (not shown). The elevator system 2 may have a traction drive including a traction sheave for driving the driving member 3. In an alternative configuration, which is not shown in the figures, the elevator system 2 may be an elevator system 2 without a driving member 3.

The elevator system 2 also may comprise e.g. a hydraulic drive or a linear drive. The elevator system 2 may have a machine room (not shown) or it may be a machine room-less elevator system 2.

The elevator system 2 further includes a counterweight 19 attached to the driving member 3 and configured for moving concurrently and in opposite direction with respect to the elevator car 6 along at least one counterweight guide member 15. The skilled person will understand that the invention may be applied also to elevator systems 2 which do not comprise a counterweight 19.

Each landing 8 has a floor 8a and is provided with a landing door 11. The elevator car 6 is provided with a corresponding elevator car door 12 for allowing passengers to transfer between a landing 8 and the interior of the elevator car 6 when the elevator car 6 is positioned at the respective landing 8.

Additionally, at least one service door 10 may provide access to the hoistway 4.

Each of the doors 10, 11, 12 is equipped with an associated door sensor 10a, 11a, 12a. Each door sensor 10a, 11a, 12a is configured for detecting whether the associated door 10, 11, 12 is open or closed, and for transmitting the result of said detection to the elevator control 9 via a wired or wireless data connection (not shown).

The elevator drive 5 is controlled by an elevator control 9 for moving the elevator car 6 along the hoistway 4 between the different landings 8.

Input to the elevator control 9 may be provided via landing control panels 7a provided on each of the landings 8, and/or via an elevator car control panel 7b provided inside the elevator car 6. The landing control panels 7a and the elevator car control panel 7b may comprise at least one hall call button 17a, which may be a destination call button, and at least one elevator car call button 17b, respectively.

The landing control panels 7a and the elevator car control panel 7b may be connected to the elevator control 9 by means of electric wires, which are not shown in FIG. 1, in particular by an electric bus, or by means of wireless data connections.

In order to facilitate repair and maintenance of the elevator system 2, a ladder 20 is provided in a lower portion 22 of the hoistway 4, which sometimes is referred to as a “pit”. The elevator system 2 further comprises a ladder sensor 24, which is configured for detecting the presence of the ladder 20 at its dedicated position within the hoistway 4 and communicating the detection result to the elevator control 9. The elevator control 9 is configured for allowing normal operation of the elevator system 2 only if the ladder 20 is detected to be located at its dedicated position within the hoistway 4, e.g. in a ladder fixture (not shown) provided within the lower portion 22 of the hoistway 4.

For maintenance and/or repair, it might be advantageous to position the elevator car 6 at a specific position (height) within the hoistway 4, in particular in a predetermined distance d from a floor 21 formed at the lower end of the hoistway 4.

The present invention is related to a method of operating the elevator system 2 in a maintenance mode for positioning the elevator car 6 at a specific position within the hoistway 4.

According to an exemplary embodiment of the invention, in a first step, the elevator control 9 is switched into a maintenance set-up mode by inputting a maintenance mode set-up signal.

The maintenance mode set-up signal may be input via a service panel 26 which is integrated and/or electrically connected with the elevator control 9. Alternatively, the maintenance mode set-up signal may be input via a separate service tool 28, which is configured for wiredly and/or wirelessly communicating with the elevator control 9. The service tool 28 may be a specific service tool 28, alternatively, the service tool 28 may be a smartphone or tablet computer running an appropriate software.

After being switched into the maintenance set-up mode, the elevator control 9 expects to receive further input. Input to the elevator control 9 in particular may be provided via the at least one hall call button 17a and/or the at least one elevator car call button 17b of one of the control panels 7a, 7b.

The elevator car 6, for example, may be moved to a desired landing 8, in particular to the lowest landing 8, or a landing immediately above the lowest landing 8, by pressing one of the hall call buttons 17a and elevator car call buttons 17b. The service person 30 may use the elevator car 6 for traveling from the top of the hoistway 4, where the elevator control 9 may be located, to the lowest landing 8, or a landing immediately above the lowest landing 8, by entering into the elevator car 6 and operating the elevator car call button 17b associated with the lowest landing 8, or a landing immediately above the lowest landing 8.

After the elevator control 9 has been switched into the maintenance set-up mode, the elevator car 6 is still moved in accordance with the normal operation mode. I.e., the elevator car 6 is moved with the same speed as in the normal operation mode, and a first set of safety conditions, which is associated with the normal operation mode, is applied.

The applied safety conditions may include limits for the speed and acceleration of the elevator car 6, limits for the positions of the elevator car 6 at the top and the bottom of the hoistway 4, etc.

After the elevator car 6 has reached the desired position within the hoistway 4, in particular a destination landing 8, such as the lowest landing 8, or a landing immediately above the lowest landing 8, the elevator system 2 is switched from the maintenance set-up mode into the maintenance mode by opening one of the doors 10, 11, in particular the lowest landing door 11, providing access to the hoistway 4.

When the elevator control 9 is operating in the maintenance mode, the elevator system 2 may be configured for issuing an optic and/or an acoustic signal indicating that the elevator control 9 is operating in the maintenance mode.

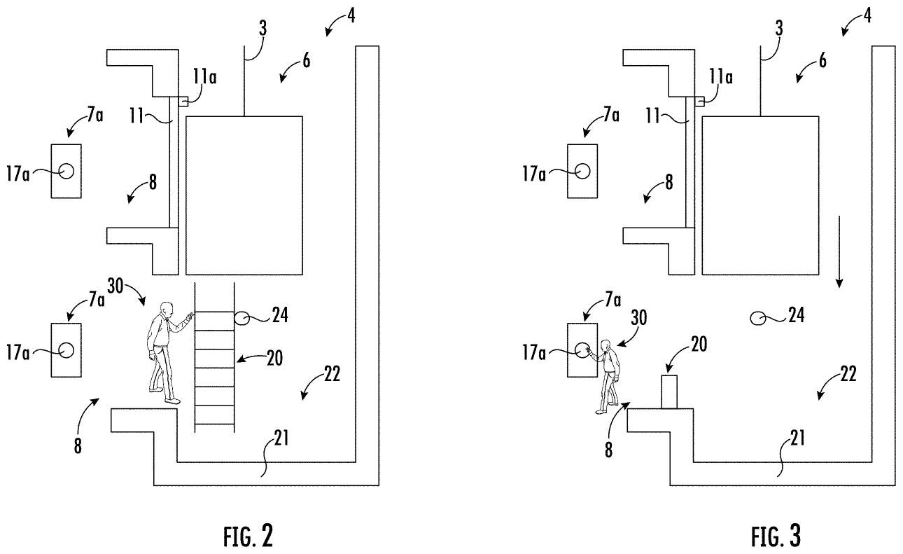

After opening the lowest landing door 11 or the service door 10 provided in a lower portion 22 of the hoistway 4, the service person 30 may enter the hoistway 4 and remove the ladder 20 provided within the hoistway 4 from its dedicated position (see FIG. 2).

After being switched into the maintenance mode, the elevator control 9 is configured to wait to receive further input signals. Again, input to the elevator control 9 may be provided via the hall call buttons 17a and/or elevator car call buttons 17b of the control panels 7a, 7b.

When switched into the maintenance mode, the elevator control 9 in particular may be configured for responding only to input signals provided via one of the hall call buttons 17a located at the lowest landing 8. I.e., input from other hall call buttons 17a, which are not located at the lowest landing 8, and input from any of the elevator car call buttons 17b may be ignored, when the elevator control 9 is operating in the maintenance mode.

The elevator control 9 may be configured for accepting input from any of the hall call buttons 17a located at the lowest landing 8. Alternatively, the elevator control 9 may be configured for accepting input only from one or more dedicated hall call buttons 17a selected from a plurality of hall call buttons 17a located at the lowest landing 8.

An input signal to the elevator control 9 in particular may be provided by pressing one of the hall call buttons 17a at the lowest landing 8 either shorter or longer than a predetermined period of time (see FIG. 3).

When one of the hall call buttons 17a at the lowest landing 8 is pressed shorter than the predetermined period of time (e.g. for a time period of less than 4 s), the elevator control 9 is configured for moving the elevator car 6 to the lowest landing 8 in an operation mode corresponding to the normal operation mode, i.e. in an operation mode in which the first set of safety conditions corresponding to normal operation is applied. The elevator control 9 further may be configured for opening the elevator car door 12 after the elevator car 6 has reached the lowest landing 8 and/or switching back the elevator control 9 from operating in the maintenance set-up mode into the normal operation mode.

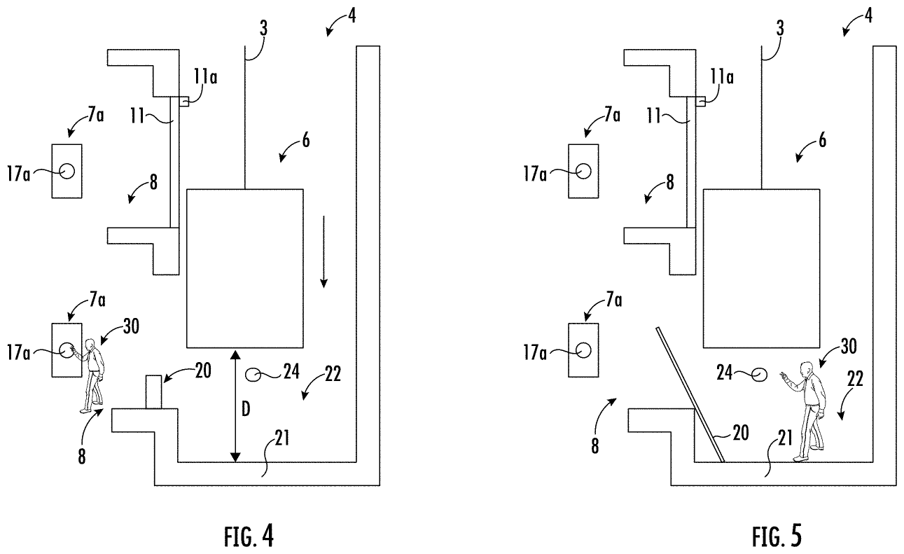

When one of the hall call buttons 17a at the lowest landing 8 is pressed longer than the predetermined period of time (e.g. for a time period of more than 4 s), the elevator control 9 is configured for recognizing this input as a service control command. In consequence, the elevator control 9 causes the elevator drive 5 to move the elevator car 6 in a predetermined direction, e.g. downwards, as long as the lowest hall call button 17a is pressed. The movement of the elevator car 6 is stopped as soon as the lowest hall call button 17a is released or the elevator car 6 moves closer than a predetermined distance D to the upper or lower end of the hoistway 4, respectively (see FIG. 4).

When the elevator car 6 is moved in the maintenance mode by pressing one of the hall call buttons 17a at the lowest landing 8 longer than the predetermined period of time, a second set of safety conditions, which differs from the first set of safety conditions, is applied.

In order to allow the elevator car 6 to be moved into a position which is suitable for repair and/or maintenance, the second set of safety condition may allow the elevator car 6 to move closer to the upper and/or lower ends of the hoistway 4 than the first set of safety conditions. On the other hand, the second set of safety conditions may restrict the maximum speed and/or maximum acceleration of the elevator car 6 to lower values than the first set of safety conditions. The second set of safety conditions further may ignore signals provided by some sensors, in particular safety sensors, such as the ladder sensor 24. This allows moving the elevator car 6 by pressing one of the hall call buttons 17a at the lowest landing 8 even after the ladder 20 has been removed from its dedicated position within the hoistway 4 in order to be used for entering the lower portion 22 (“pit”) of the hoistway 4 (see FIGS. 4 and 5).

The elevator control 9 may be configured for reversing the moving direction of the elevator car 6 in the maintenance mode if one of the hall call buttons 17a at the lowest landing 8 is released after it has been pressed longer than the predetermined period of time, and is then pressed again longer than the predetermined period of time. Such a configuration allows the service person 30 to move the elevator car 6 in both directions by alternately releasing and pressing one of the hall call buttons 17a at the lowest landing 8 for more than the predetermined period of time. In an alternative configuration, the two different moving directions (up and down) may be assigned to two different hall call buttons 17a, which allows moving the elevator car 6 in the desired direction by pressing the corresponding hall call button 17a longer than the predetermined period of time.

The elevator control 9 further may be configured for switching back to operating the elevator system 2 in the normal operation mode if one of the hall call buttons 17a at the lowest landing 8 is released and then pressed again shorter than the predetermined period of time. This allows the service person 30 to easily switch the elevator control 9 back to operating the elevator system 2 in the normal operation mode after the repair and/or maintenance of the elevator system 2 has been completed.

The elevator control 9 further may be configured for detecting and monitoring the time lapsed between successive inputs provided to the elevator control 9; and for switching back to operating the elevator system 2 in the normal operation mode if the detected time lapsed between two successive inputs exceeds a preset period of time. The elevator control 9 in particular may be configured to switch back from the maintenance set-up mode into the normal operation mode without entering the maintenance mode if none of the doors 10, 11 providing access to the hoistway 4 is opened within a predetermined period of time after the maintenance mode set-up signal has been received. This prevents the elevator system 2 from accidentally being operated in the maintenance set-up mode over an extended period of time.

For some sort of repair and/or maintenance, it may be necessary for the service person 30 to access the top 6a and/or the bottom 6b of the elevator car 6. It therefore is desirable to provide a method which allows positioning the elevator car 6 easily at a position (height) within the hoistway 4 which allows easy access to the top 6a or to the bottom 6b of the elevator car 6 from one of the landings 8 or from the floor 21 at the bottom of the hoistway 4, respectively.

In order to provide such a method, the elevator control 9 may be configured for controlling the elevator drive 5 to move the elevator car 6 in accordance with a top of the car elevator car positioning mode (“TOC routine”). The TOC routine is configured for automatically positioning the top 6a of the elevator car 6 at a predetermined distance from one of the landings 8.

The TOC routine is initiated after the elevator car 6 has been positioned at one of the landings 8, as it is depicted in FIG. 1. In the configuration depicted in FIG. 1, the bottom (floor) 6b of the elevator car 6 is aligned, i.e. arranged basically at the same height, as the floor 8a of one of the landings 8.

The TOC routine is initiated by providing a TOC enable signal to the elevator control 9. Similar to maintenance mode set-up signal, the TOC enable signal may be input via a service panel 26 provided at the elevator control 9, or via a separate service tool 28 which is configured for wiredly and/or wirelessly communicating with the elevator control 9. Alternatively, the TOC enable signal may be input via one of the landing control panels 7a.

For safety reasons, the TOC enable signal is ignored if the elevator control 9 has not been switched into the maintenance mode or the maintenance set-up mode before the TOC enable signal is entered.

In response to receiving the TOC enable signal after being switched into the maintenance mode or the maintenance set-up mode, the elevator control 9 controls the elevator drive 5 to move the elevator car 6 downwards over a predetermined distance in order to provide easy access to the top of the elevator car 6 from the respective landing 8.

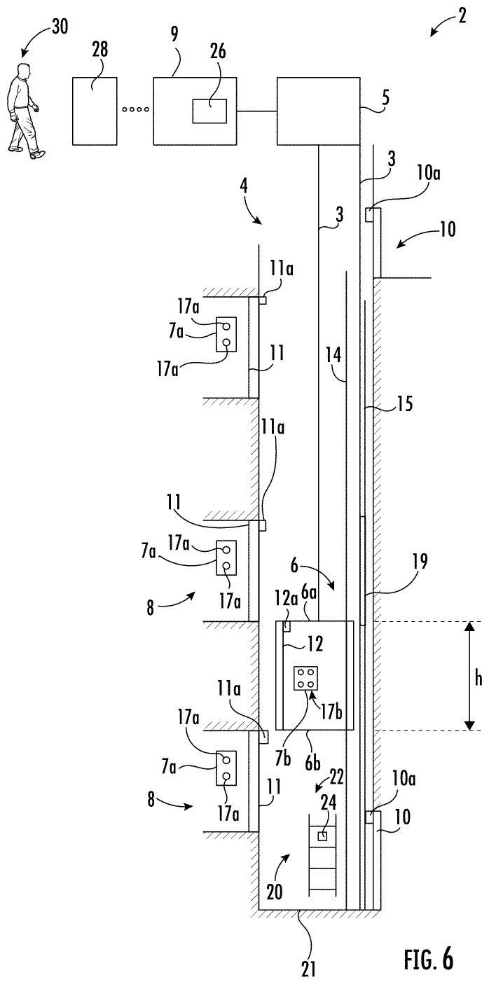

The elevator car 6 in particular may be lowered over a distance basically corresponding to the height h of the elevator car 6. As a result, the top 6a of the elevator car 6 is aligned with the respective landing 8 allowing the service person 30 to easily step from the landing 8 onto the top 6a of the elevator car 6 (see FIG. 6).

Alternatively, the elevator car 6 may be lowered over a distance which is shorter than the height h of the elevator car 6 in order to provide a service person 30 standing at one of the landings 8 with easy and comfortable access to components (not shown) arranged on the top 6a of the elevator car 6.

The elevator control 9 may offer two or more different TOC modes, wherein each TOC mode is configured for moving the elevator car 6 over different distances in response to receiving a different TOC enable signal, respectively. Such a configuration allows the service person 30 to selectively move the top 6a of the elevator car 6 to a desired distance from the respective landing 8, i.e. the distance between the top 6a of the elevator car 6 and the respective landing 8 may be adjusted differently depending on the work to be done on/at the top 6a of the elevator car 6.

After the work on/at the top 6a of the elevator car 6 has been finished, the elevator car 6 may be moved back into a “normal position”, i.e. into a position in which the bottom 6b of the elevator car 6 is aligned with the floor 8a of one of the landings 8 (see FIG. 1), by inputting a corresponding signal (“TOC disable signal”) into the elevator control 9. The TOC disable signal may be input into the elevator control 9 by the same means as the TOC enable signal.

For providing easy access to the bottom of the elevator car 6, the bottom 6b of the elevator car 6 may be arranged at a predefined distance from a floor 8a of a landing 8 by moving the elevator car 6 upwards over a predetermined distance from one of the landings 8 by performing a BOC (bottom of car) routine, which is similar to positioning the top 6a of the elevator car 6 at a predefined distance from a floor 8a of a landing 8 by performing TOC routine, as it has been described before.

While the invention has been described with reference to exemplary embodiments, it will be understood by those skilled in the art that various changes may be made and equivalents may be substituted for elements thereof without deportioning from the scope of the invention. In addition, many modifications may be made to adopt a particular situation or material to the teachings of the invention without deportioning from the essential scope thereof. Therefore, it is intended that the invention shall not be limited to the particular embodiment disclosed, but that the invention includes all embodiments falling within the scope of the dependent claims.

### References

2 elevator system
3 driving member
4 hoistway
5 elevator drive
6 elevator car
6a top of the elevator car
6b bottom of the elevator car
7a landing control panel
7b elevator car control panel
8 landing
8a floor of a landing
9 elevator control
10 service door
10a door sensor
11 landing door
11a door sensor
12 elevator car door
12a door sensor
14 car guide member
15 counterweight guide member
17a hall call button
17b elevator car call button
19 counterweight
20 ladder
21 floor
22 bottom of the hoistway
24 ladder sensor
26 service panel
28 service tool
30 service person

What is claimed is:

1. Elevator system (2) comprising:
a hoistway (4) extending between a plurality of landings (8);
at least one elevator car (6) configured for moving along the hoistway (4) between the plurality of landings (8);
an elevator drive (5) configured for moving the at least one elevator car (6) along the hoistway (4); and
an elevator control (9) configured for controlling the elevator drive (5); wherein the elevator control (9) is configured for selectively operating in a normal operation mode or in a maintenance mode;
wherein the elevator control (9) is further configured to perform operations comprising:
switching the elevator control (9) into a maintenance set-up mode in response to receiving a maintenance mode set-up signal;
when switched into the maintenance set-up mode and in response to receiving an input signal, controlling the elevator drive (5) for moving the elevator car (6) in accordance with the normal operation mode to a position specified by the input signal;
when the elevator car (6) has reached the specified position, switching into the maintenance mode in response to detecting an opening of at least one door (10, 11) providing access to the hoistway (4);
in response to detecting that a predefined call button (17a, 17b) has been operated for at least a predetermined period of time, controlling the elevator drive (5) for moving the elevator car (6) in accordance with the maintenance mode.

2. Elevator system (2) according to claim 1, wherein, when switched into the maintenance mode, the elevator control (9) is configured for controlling the elevator drive (5) for moving the elevator car (6) until it reaches a predetermined position within the hoistway (4) and/or until the call button (17a, 17b) is released, if the call button (17a, 17b) has been operated at least for the predetermined period of time, and/or the elevator control (9) is configured for controlling the elevator drive (5) for moving the elevator car (6) in accordance with the normal operation mode if the call button (17a, 17b) has been operated shorter than the predetermined period of time.

3. Elevator system (2) according to claim 1, wherein, when switched into the maintenance mode, the elevator control (9) is configured for controlling the elevator drive (5) for moving the elevator car (6) in the opposite direction after the call button (17a, 17b) has been released and is operated again at least for the predetermined period of time.

4. Elevator system (2) according to claim 1, wherein the elevator control (9) is configured for receiving the maintenance mode set-up signal via a service panel (26) integrated and/or electrically connected with the elevator control (9) and/or via a separate service tool (28) which is wiredly and/or wirelessly connectable with the elevator control (9), wherein the service tool (28) in particular includes a smartphone or a tablet computer.

5. Elevator system (2) according to claim 1, wherein, when switched into the maintenance mode, the elevator control (9) is configured for applying a first set of safety conditions when the elevator car (6) is moved in accordance with the normal operation mode, and for applying a second set of safety conditions different from the first set of safety conditions when the elevator car (6) is moved in accordance with the maintenance mode.

6. Elevator system (2) according to claim 5, wherein, when controlling the elevator drive (5) for moving the elevator car (6) in accordance with the maintenance mode, the elevator control (9) is configured for ignoring signals of at least one sensor (10a, 11a, 12a, 24) applied when controlling the elevator drive (5) for moving the elevator car (6) in the normal operation mode, such as the signal of a ladder detection sensor (24), which is configured for detecting the presence of a ladder (20) within the hoistway (4), and/or the signal of a door sensor (10a, 11a, 12a), which is configured for detecting whether a door (10, 11, 12) is open or closed.

7. Elevator system (2) according to claim 1, wherein, when switched into the maintenance mode, the elevator control (9) is further configured for controlling the elevator drive (5) for moving the elevator car (6) in accordance with an elevator car positioning mode for automatically positioning the top (6a) and/or the bottom (6b) of the elevator car (6) at a predetermined distance from a respective one of the landings (8).

8. Elevator system (2) according to claim 7, wherein the elevator car positioning mode in particular includes moving the elevator car (6) over a predetermined length, which in particular corresponds to the height (h) of the elevator car (6), for positioning the top (6a) and/or the bottom (6b) of the elevator car (6) at a predetermined distance from the respective landing (8).

9. Elevator system (2) according to claim 1, wherein the elevator control (9) is configured for detecting the time lapsed in between at least two of operations, and for switching back into the normal operation mode when it is detected that the time lapsed in between two successive operations exceeds a predetermined threshold.

10. Method of moving an elevator car (6) of an elevator system (2) according to claim 1 in accordance with a maintenance mode, wherein the method includes:
switching the elevator control of the elevator system into a maintenance set-up mode by providing a maintenance mode set-up signal to the elevator control (9);
when switched into the maintenance set-up mode, providing an input signal for moving the elevator car (6) in accordance with the normal operation mode to a position specified by the input signal;
when the car has reached the specified position, opening a door (10, 11) providing access to the hoistway (4);
operating a call button (17a, 17b) for at least a predetermined period of time for moving the elevator car (6) in accordance with the maintenance mode.

11. Method according to claim 10, wherein, when switched to the maintenance mode, the elevator car (6) is controlled to move until it reaches a predetermined position and/or until the call button (17a, 17b) is released, if the call button (17a, 17b) is operated at least for the predetermined period of time, and/or wherein the elevator car (6) is controlled to move in accordance with the normal operation mode if the call button (17a, 17b) is operated shorter than the predetermined period of time, and/or wherein the elevator car (6) is controlled to move in the opposite direction after the call button (17a, 17b) has been released and is operated again at least for the predetermined period of time.

12. Method according to claim 10 wherein the maintenance mode set-up signal is provided via a service panel (26), which is integrated and/or electrically connected with the elevator control (9), and/or via a separate service tool (28), which is wiredly and/or wirelessly connected with the elevator control (9), wherein the service tool (28) in particular includes a smartphone or a tablet computer.

13. Method according to claim 10, wherein, when switched into the maintenance mode, a first set of safety conditions is applied when the elevator car (6) is controlled to move in accordance with the maintenance mode, and a second set of safety conditions different from the first set of safety conditions is applied when the elevator car (6) is controlled to move in accordance with the normal operation mode, wherein moving the elevator car (6) in accordance with the maintenance mode in particular includes ignoring signals provided by at least one sensor (10a, 11a, 12a, 24), such as the signal of a ladder detection sensor (24) configured for detecting the presence of a ladder (20) and/or the signal of a door sensor (10a, 11a, 12a) configured for detecting whether an associated door (10, 11, 12) is open or closed.

14. Method according to claim 10, wherein moving the elevator car (6) in accordance with the maintenance mode includes moving the elevator car (6) in accordance with an elevator car positioning mode, which includes automatically positioning the top (6a) and/or the bottom (6b) of the elevator car (6) at a predetermined distance from one of the landings (8), wherein moving the elevator car (6) in accordance with the elevator car positioning mode in particular includes moving the elevator car (6) over a predetermined length, in particular the height (h) of the elevator car (6), for positioning the top (6a) and/or the bottom (6b) of the elevator car (6) at a predetermined distance from the respective landing (8).

15. Method according to claim 10, wherein the elevator control (9) switches back into the normal operation mode when the time lapsed in between two operations exceeds a predetermined threshold.
